(19) United States
(12) Patent Application Publication
(10) Pub. No.: US 2019/0314991 A1
(43) Pub. Date: Oct. 17, 2019

(54) METHOD FOR CONTROLLING ROBOT MOVEMENT AND ROBOT

(71) Applicant: GUANGDONG BONA ROBOT CORPORATION LIMITED, Shenzhen (CN)

(72) Inventors: HAOXIN LIU, Shenzhen (CN); Xianwei Zhou, Shenzhen (CN); Kai Yang, Shenzhen (CN); Yibo Cao, Shenzhen (CN)

(21) Appl. No.: 16/443,893

(22) Filed: Jun. 18, 2019

Related U.S. Application Data
(63) Continuation of application No. PCT/CN2017/086187, filed on May 26, 2017.

(30) Foreign Application Priority Data
Jan. 9, 2017 (CN) 201710013906.0

(51) Int. Cl. B25J 9/16; B25J 11/00

(52) U.S. Cl. CPC B25J 9/1666; A47L 11/24; B25J 11/0085

(57) ABSTRACT

A robot movement control method includes: acquiring position information about two adjacent obstacles located on two sides of a robot along the robot moving direction or a perpendicular direction to the movement direction, and calculating distance therebetween; determining whether the distance is greater than a first pre-set distance; defining a virtual obstacle boundary between the two adjacent obstacles if the distance therebetween is not greater than the first preset distance; and controlling movement paths of the robot by means of the virtual obstacle boundary. Also disclosed is a robot, including: a position acquisition module for acquiring position information of two adjacent obstacles, and calculating distance therebetween; a distance determination module for determining whether the distance is greater than a first pre-set distance; a boundary defining module for defining virtual obstacle boundaries; and a movement control module for controlling movement paths of the robot by means of the virtual obstacle boundary.

### CROSS REFERENCE TO RELATED APPLICATIONS

The present application is a continuation-application of International (PCT) Patent Application No. PCT/CN2017/086187 filed or May 26, 2017, which claims foreign priorities of Chinese Patent Application No. 201710013906.0, filed on Jan. 9, 2017, in China National Intellectual Property Administration, the entire contents of which are hereby incorporated by reference in their entireties.

### TECHNICAL FIELD

The present disclosure relates to the field of robots, and in particular to a method for controlling robot movements and a robot.

### BACKGROUND

As an intelligent device, a robot serves for human, and users of robots usually control robot movements when the robots are performing tasks. For example, a robot is performing a task within a certain area, then the robot may not be allowed to move out of the area until the task is finished. Currently in the art, the robot working area is limited by obstacle signals generated by a virtual wall generation device, or by a virtual obstacle boundary, which is in a pattern form and can be recognized by the robot.

However, when a robot is required to move across and cover a large area, users may need multiple virtual wall generation devices or patterns to divide the robot working area into multiple sub-regions, which increases cost.

### SUMMARY OF THE DISCLOSURE

The present disclosure is to solve the problem that, in the art, virtual wall generation devices or patterns are required to generate virtual obstacle boundaries.

To solve the above-mentioned problem, the present disclosure is to provide a robot, including a position acquiring module, which acquires position information of two adjacent obstacles located on two sides of the robot along the robot moving direction or a direction perpendicular to the moving direction, and calculates distance between the two adjacent obstacles; a distance determination module, which determines whether the distance between the two adjacent obstacles is less than or equal to a first preset distance; a boundary defining module. which defines a virtual obstacle boundary between the two adjacent obstacles when the distance between the two adjacent obstacles is less than or equal to the first preset distance; and a movement controlling module, which controls robot moving paths based on the virtual obstacle boundary. When the robot subsequently moves to reach the virtual obstacle boundary, the movement controlling module may be further used to control the robot movement by defining obstacles at the virtual obstacle boundary. The position acquiring module may then obtain a virtual map of a nonworking area, wherein the virtual map is divided into girds in an array. When the robot is in the process of moving, the position acquiring module may detect status of grids, which are adjacent to the grid that the robot is located, along the robot moving direction or perpendicular to the moving direction. The status of each grid may be recorded on the virtual map, wherein grids, which are passed by the robot, may be recorded as operated grids; grids, which are detected to contain obstacles, may be recorded as obstacle grids; grids, which have not been passed by the robot and are detected to not contain any obstacle, may be recorded as grids to be operated; and grids, which have not been passed by the robot and have not undergone the detection process, may be recorded as unknown grids.

To solve the above-mentioned technical problem, the present disclosure is to provide another solution, which is a method for controlling robot movement, including: acquiring position information of two adjacent obstacles located on two sides of the robot along the robot moving direction or a direction perpendicular to the moving direction, calculating distance between the two adjacent obstacles; determining whether the distance between the two adjacent obstacles is less than or equal to a first preset distance, defining a virtual obstacle boundary between the two adjacent obstacles when the distance between the two adjacent obstacles is less than or equal to the first preset distance, and controlling movement paths of the robot based on the virtual obstacle boundary.

To solve the above-mentioned technical problem, the present disclosure is to provide another solution, which is a robot including a sensor and a processor interconnected with each other. The sensor may acquire position information of two adjacent obstacles located on two sides of the robot along the robot moving direction or a direction perpendicular to the moving direction, and the processor may calculate distance between the two adjacent obstacles, determining whether the distance between the two adjacent obstacles is less than or equal to a first preset distance. When the distance between the two adjacent obstacles is less than or equal to the first preset distance, the processor may define a virtual obstacle boundary between the two adjacent obstacles, and control moving paths of the robot based on the virtual obstacle boundary.

Differentiating from the current skills available in the art, the present disclosure is to acquire position information of two adjacent obstacles located on two sides of a robot along the robot moving direction or a direction perpendicular to the moving direction, calculate distance between the two adjacent obstacles, and define a virtual obstacle boundary between the two adjacent obstacles when the distance between the two adjacent obstacles is less than or equal to a first preset distance. External virtual wall generation devices may not be required, defining virtual obstacle boundaries may be performed by the robot itself, which efficiently reduces cost.

### BRIEF DESCRIPTION OF DRAWINGS

FIG. 1 is a flow chart of one embodiment illustrating a method for controlling robot movement.

FIG. 2 is a virtual map for the robot controlled by the method shown in FIG. 1.

FIG. 3 illustrates that a virtual obstacle boundary is defined along a row direction by the method shown in FIG. 1, when the robot is moving along the row direction.

FIG. 4 illustrates that a virtual obstacle boundary is defined along a column direction by the method shown in FIG. 1, when the robot is moving along a row direction.

FIG. 5 illustrates that a virtual obstacle boundary is defined along a row direction by the method shown in FIG. 1, when the robot is moving along a column direction.

FIG. 6 is the virtual obstacle boundary illustrated in FIG. 3.

FIG. 7 is the virtual obstacle boundary illustrated in FIG. 4.

FIG. 8 is the virtual obstacle boundary illustrated in FIG. 5.

FIG. 9 illustrates that two virtual obstacle boundaries defined along the row direction by the method shown in FIG. 1 are too close.

FIG. 10 illustrates that two virtual obstacle boundaries defined along the column direction by the method shown in FIG. 1 are too close.

FIG. 11 illustrates that the virtual obstacle boundary along the row direction and (the virtual obstacle boundary along the column direction defined by the robot controlling method shown in FIG. 1 have an overlapping region.

FIG. 12 illustrates robot moving paths defined by the method shown in FIG. 1, when the robot is in a to-be-operated region, which has a single virtual obstacle boundary.

FIG. 13 illustrates a to-be-operated region with a plurality of virtual obstacle boundaries defined by the method shown in FIG. 1.

FIG. 14 illustrates a robot moving path in a to-be-operated region defined by a current method available in the related art.

FIG. 15 illustrates the robot controlled by the method in FIG. 1 detects communication between two sub-regions via an operated grid and a to-be-operated grid during the process of moving.

FIG. 16 is a structural view of a first implementation of the robot in the present disclosure.

FIG. 17 is a structural view of a second implementation of the robot in the present disclosure.

### DETAILED DESCRIPTION

Technical solutions of embodiments in the present disclosure are to be clearly and completely described referring to appended figures. Obviously, embodiments to be described are only a part but not all of the available embodiments for the present disclosure. Based on the embodiments in the present disclosure, any other embodiments made by ordinary skilled personnel in the art without creative endeavor should be within the scope of the present disclosure.

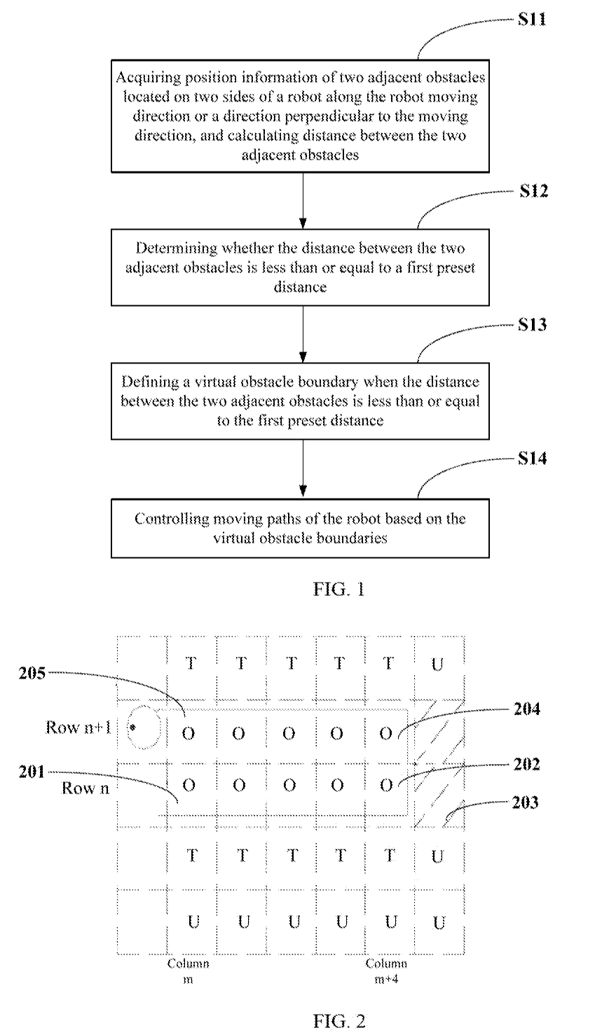

Referring to FIG. 1, a flow chart of an embodiment showing a method for controlling robot moving is provided. According to FIG. 1, the method for controlling the robot moving may include the following blocks.

Block S11: position information of two adjacent obstacles located on two sides of a robot along the robot moving direction or a direction perpendicular to the moving direction may be acquired, and distance between the two adjacent obstacles may be calculated.

Before the block S11, the method may further include S101: obtaining a virtual map of a to-be-operated region for the robot, wherein the virtual map is divided into a plurality of grids in an array. To be specific, referring to FIG. 2, in one embodiment, when the robot starts working, a virtual map of to-be-operated areas for the robot may be stored in a form of a plurality of grids in an array, wherein the robot may have at least one sensor, which has a detection range, and the robot may obtain status of each grid within the detection range via the sensor and make marks on the virtual map accordingly, any grid out of the detection range may be marked as unknown.

S102: during the process of robot moving, status of grids adjacent to the robot located grid along the robot moving direction and the direction perpendicular to the moving direction may be detected, and the status of the grids may be marked on the virtual map, wherein grids that are passed by the robot may be marked as operated grids, grids that contain obstacles may be marked as obstacle grids, grids that are detected as obstacle free and never passed by the robot may be marked as to-be-operated grids, and grids that are never passed by the robot and the status thereof are not detected may be marked as unknown grids.

To be specific, in the above embodiment, the robot may have two modes of moving: row by row moving and column by column moving. Further referring to FIG. 2, row by row moving means that the robot may firstly move along a row direction, when encountering an obstacle, the robot may move to a next row along a column direction perpendicular to the row direction, and then move along the next row in a reversed direction with respect to the previous row direction. For example, in the virtual map, the robot may firstly move from position 201, which is located at row n of column m, to position 202, which is located at row n of column m+4. As an obstacle is at position 203, which is located at row n of column m+5, the robot may move along a column direction perpendicular to the row direction, from the position 202 at row n of column m+4 to position 204 located at row n+1 of column m+4, and then continue moving along row n+1 from the position 204 at row n+1 of column m+4 to position 205 located at row n+1 of column m. Column by column moving means that the robot may firstly move long a column direction, when encountering an obstacle, the robot may move to a next column along a row direction perpendicular to the column direction, and then move along the next column in a reversed direction with respect to the previous column direction.

In the example of row by row moving mode, during the moving process, status of the grids adjacent to the robot located grid along the moving direction (row direction) and the perpendicular direction (column direction) may be detected and marked on the virtual map. The status of the grids may be updated while the robot moving. As shown in FIG. 2, the grids that are passed by the robot and the grid, which the robot is located at, may be marked as operated grids shown with a letter “O” in FIG. 2; the grids, which are detected as containing obstacles, may be marked as obstacle grids, which are shown as crossed in FIG. 2; the grids, which are detected as obstacle free and have not been passed by the robot, may be marked as to-be-operated grids shown with a letter “T” in FIG. 2; the grids, which have not been passed by the robot and the status thereof have not be detected, may be marked as unknown and shown with a letter “U” in FIG. 2.

In other embodiments, the robot may move along other directions, and the virtual map may be stored by other means, which will not be limited herein.

Further, the block S11 may include S111: acquiring two adjacent obstacle grids located on two sides of the robot along the moving direction or the direction perpendicular to the moving direction, and calculating distance between the two adjacent obstacle grids based on the position information of the two adjacent obstacle grids on the virtual map.

The S111 may further include S1111: along the moving direction of the robot or a direction perpendicular to the robot moving direction, acquiring position information of a first obstacle located on one side of the robot and a second obstacle located on another side of the robot, wherein a region between the first and the second obstacles may be obstacle free.

To be specific, in one embodiment, as shown in FIG. 3, when the robot is moving along a row direction on row n, position information of two adjacent obstacle grids, which contain the first and the second obstacles, are acquired, which is the position information of the position 301 at row n of column m+1 and the position 302 at row n of column m−j on the virtual map, so that distance between the two adjacent obstacle grids may be calculated as j+1 grids. In other embodiments, position information of the first and the second obstacles may be acquired along a direction perpendicular to the robot moving direction, which will not be limited herein.

Block S12: it may be determined whether the distance between two adjacent obstacles is equal to or less than a first preset distance.

To be specific, the robot may preset a first threshold distance as the first preset distance. In the above embodiment, the first preset distance may be expressed in grids as unit, wherein a specific value may be determined based on actual demand, which will not be limited herein.

The block S12 may further include S121: determining whether a to-be-operated grid is located on at least one side of a grid between the two adjacent obstacle grids and whether the to-be-operated grid communicates with an unknown grid.

To be specific, in the above embodiment, as shown in FIG. 3, the robot is located at position 300 at row n of column m of the virtual map, position 301 at row u of column m+1 and position 302 at row n of column m−j are both obstacle grids. When a to-be-operated grid is located on one side (row n+1) of the grids between the two obstacle grids, and the to-be-operated grid communicates with an unknown grid, for example, a to-be-operated grid 304 at row n+1 of column m is located next to and communicates with the unknown grid 303 (row n+1 of column m+1), then a virtual obstacle boundary may be defined while the robot is moving from the operated region to the to-be-operated region.

Block S13: When the distance between the two adjacent obstacles is equal to or less than the first preset distance, a virtual obstacle boundary may be defined between the two adjacent obstacles.

Further, the block S13 may include S131: defining a virtual obstacle boundary between the two adjacent obstacle grids, when the distance between the two adjacent obstacle grids is equal to or less than the first preset distance, and a to-be-operated grid is located on at least one side of the grid between the two adjacent obstacle grids and communicates with an unknown grid.

To be specific, in the above embodiment, as shown in FIG. 3, when the distance between the two adjacent obstacle grids 301 and 302 (wherein the distance is equal to j+1 grids) is less than or equal to a first preset distance (for example, 10 grids), and a to-be-operated grid is located on at least one side of the grids between the two adjacent obstacle grids 301 and 302 and communicates with an unknown grid, for example, when a to-be-operated grid 304 is located next to and communicates with the unknown grid 303, then a virtual obstacle boundary may be defined between the two adjacent obstacle grids 301 and 302.

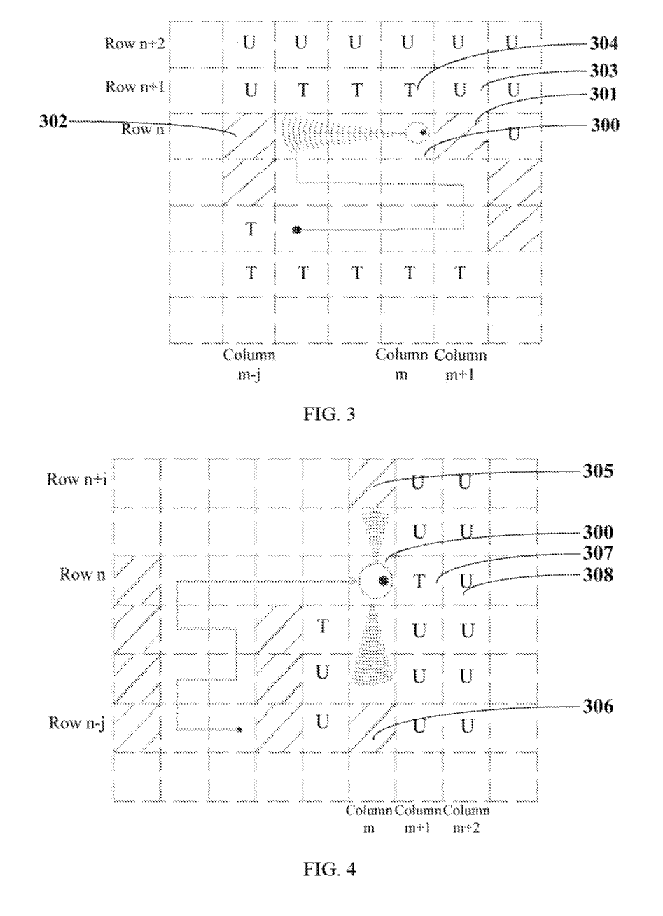

In another embodiment, referring to FIG. 4, the robot may move along the row direction on the virtual map and may be located at position 300 at row n of column m at the moment, when the distance between the two adjacent obstacle 305 and 306 (i+j grids), which are located on two opposite sides of the robot, is less than or equal to the first preset distance (for example, 10 grids), and a to-be-operated grid is located on at least one side of the grid between the two adjacent obstacle grids 305 and 306 and communicates with an unknown grid, for example, a to-be-operated grid may be located at position 307, which is next to and communicates with an unknown grid 308 at row n of column m+2, then a virtual obstacle boundary between the two adjacent obstacle grids 305 and 306 may be defined.

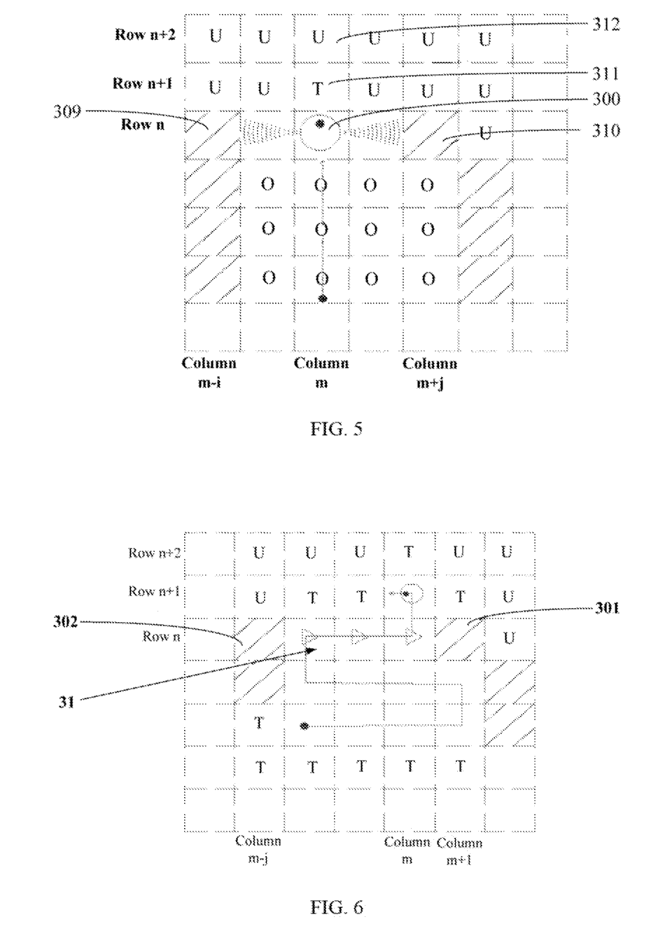

Referring to FIG. 5, the robot may be moving along a column direction on the virtual map, and located at position 300 at row u of column m at the moment, when distance between two adjacent obstacle grids 309 and 310 (wherein the distance is equal to i+j grids), which are located on two sides of the robot, is less than or equal to a first preset distance (for example, 10 grids), and a to-be-operated grid is located on at least one side of the grid between the two adjacent obstacle grids 309 and 310 and communicates with an unknown grid, for example, a to-be-operated grid located at position 311, which is next to and communicates with an unknown grid 312 at row n+2 of column m, then a virtual obstacle boundary may be defined between the two adjacent obstacle grids 309 and 310.

S132 may be performed as: controlling the robot to continue moving till the robot moves out of grids between the two adjacent obstacle grids, and defining a virtual obstacle boundary between the two adjacent obstacle grids.

To be specific, referring to FIG. 3 and FIG. 6, when the robot moves along the column direction reaching the next row (i.e. row n+1), the robot may have moved out of the grids between two adjacent obstacle grids 301 and 302, then a virtual obstacle boundary 31 may be defined between the two adjacent obstacles 301 and 302, meaning that the virtual obstacle boundary 31 may be effective, and the grids may be marked with “ [symbol] ”as shown in FIG. 6.

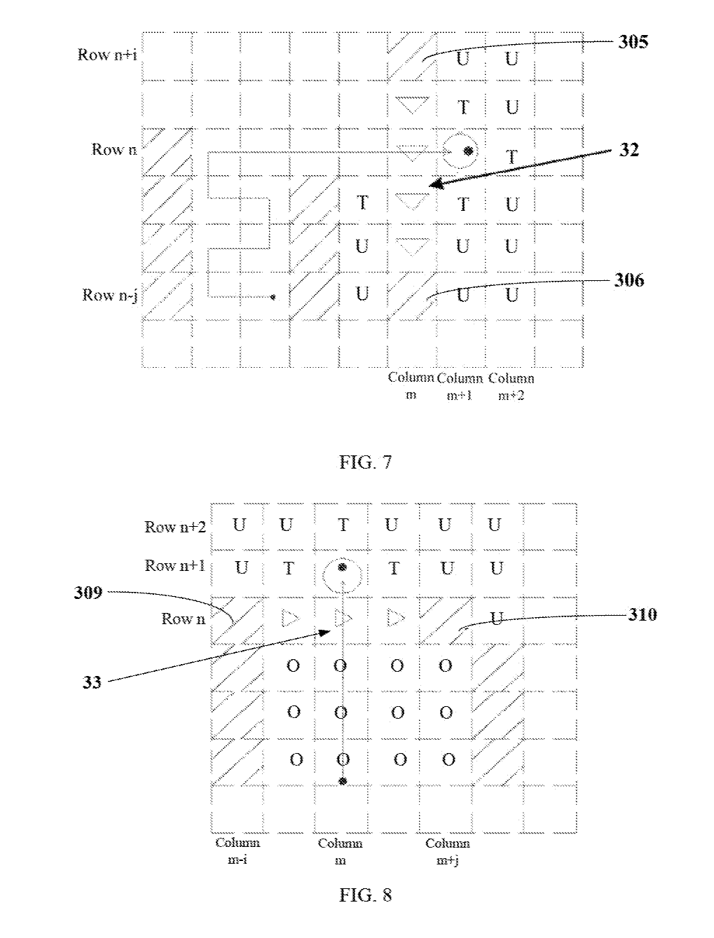

Referring to FIG. 4 and FIG. 7, when the robot moves along the row direction reaching the next column (column m+1), the robot may have moved out of the grids between two adjacent obstacles 305 and 306, a virtual obstacle boundary 32 may be defined between the two adjacent obstacles 305 and 306, meaning that the virtual obstacle boundary 32 may be effective, and the grids may be marked with “ [symbol] ”as shown in FIG. 7.

The block S13 may further include S133: when the virtual map has two or more than two virtual obstacle boundaries, determining whether distance between two of the virtual obstacle boundaries along a first direction and a second direction, which is perpendicular the first direction, either of which is less than a second preset distance, and whether projections of the two boundaries along the direction other than the one for calculating the distance have an overlapping area.

The second preset distance is a second threshold distance defined by the robot, which may depend on the actual demand, and will not be limited herein. In one embodiment, a first direction on the virtual map is the row direction, and a second direction on the virtual map is the column direction. It may be determined whether the distance between two virtual obstacle boundaries along any one of the directions, either the row direction or the column direction, is less than the second preset distance, and whether the projections of the virtual boundaries along the direction other than the one used for calculating the boundary distance have an overlapping area, so that it may be determined whether the two virtual obstacle boundaries are defined too close.

S134: when the distance between two virtual obstacle boundaries is less than the second preset distance, and has an overlapping projection area, then one of the boundaries may be selected to be deleted.

To be specific, in one embodiment, referring to FIG. 9, on a virtual map, distance between two adjacent virtual obstacle boundaries 41 and 42 along the row direction (i grids) may be less than a second preset distance (for example, 5 grids), and the virtual obstacle boundaries 41 and 42 have an overlapping projection area 401 along the column direction, indicating the two adjacent virtual obstacle boundaries 41 and 42 may be too close, any one of the boundaries may be selected to be deleted.

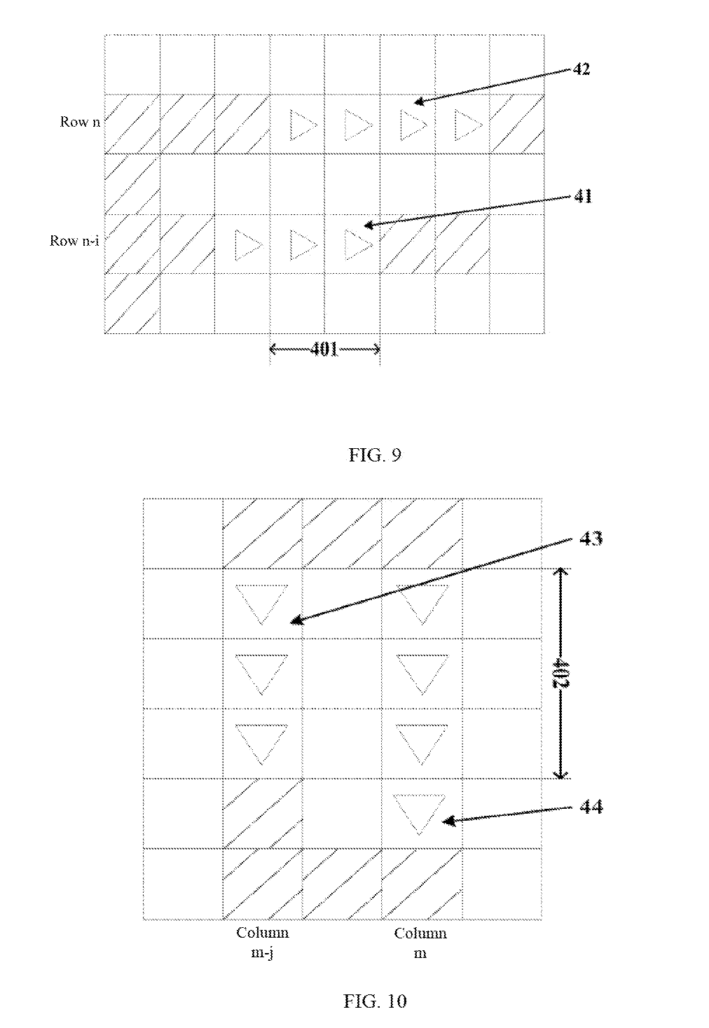

Referring to FIG. 10, on a virtual map, distance between two adjacent virtual obstacle boundaries 43 and 44 along the column direction (j grids) may be less than a second preset distance (for example, 5 grids), and the virtual obstacle boundaries 43 and 44 have an overlapping projection area 402 along the row direction, indicating that the two adjacent virtual obstacle boundaries 43 and 44 may be too close, and any one of the boundaries may be selected to be deleted.

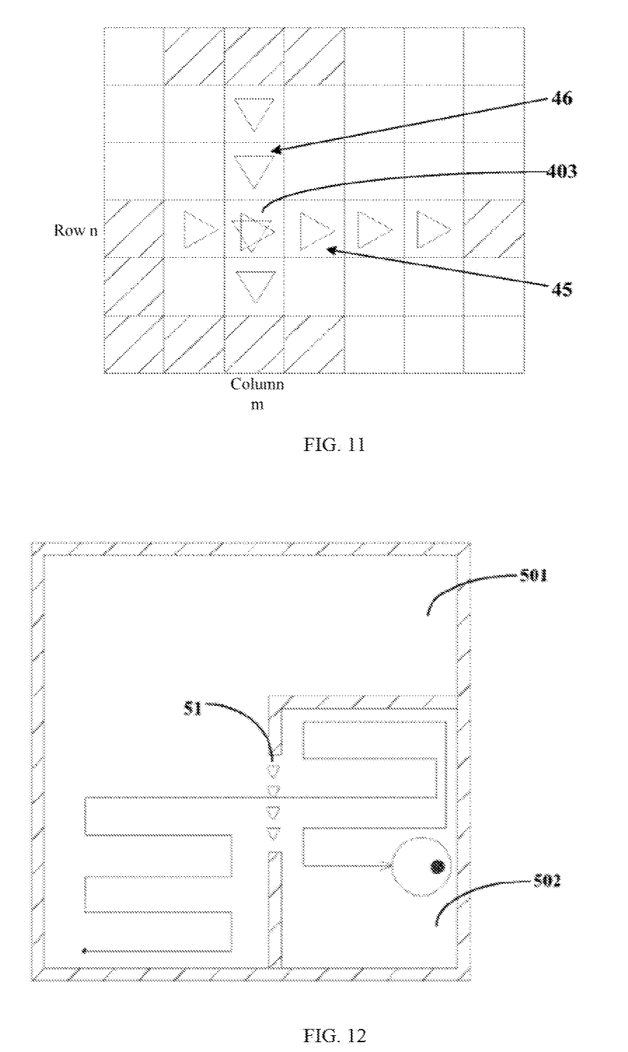

Referring to FIG. 11, on a virtual map, distance between a virtual obstacle boundary 45 along the row direction and a virtual obstacle boundary 46 along the column direction may be defined as 0, which is less than a second preset distance (for example, 5 grids), and the virtual obstacle boundaries 45 and 46 have an overlapping area 403, indicating that the two virtual obstacle boundaries 45 and 46 may be too close, and any one of the two boundaries may be selected lo be deleted.

Further, the S134 may include S1341: deleting the virtual obstacle boundary, which is defined at a later time.

To be specific, in the above embodiment, referring to FIG. 9, the virtual obstacle boundary 42 may be defined later than the virtual obstacle boundary 41, then the virtual obstacle boundary 42 may be deleted. Referring to FIG. 10, the virtual obstacle boundary 44 may be defined later than the virtual obstacle boundary 43, then the virtual obstacle boundary 44 may be deleted. Referring to FIG. 11, the virtual obstacle boundary 46 may be defined later than the virtual obstacle boundary 45, then the virtual obstacle boundary 46 may be deleted.

Block S14: the robot moving paths may be controlled by virtual obstacle boundaries.

The block S14 may include S141: controlling the robot to move by defining obstacles at virtual obstacle boundaries, when the robot moves to reach virtual obstacle boundaries.

To be specific, after a virtual obstacle boundary is effective, the robot may treat the position of which a virtual obstacle boundary is located as containing an obstacle. During the subsequent moving process, the robot may not be able to cross grids, which are located at the virtual obstacle boundary, until the virtual obstacle boundary is deleted.

Further, the S141 may include S1411: dividing the to-be-operated region into at least two sub-regions using the virtual obstacle boundary.

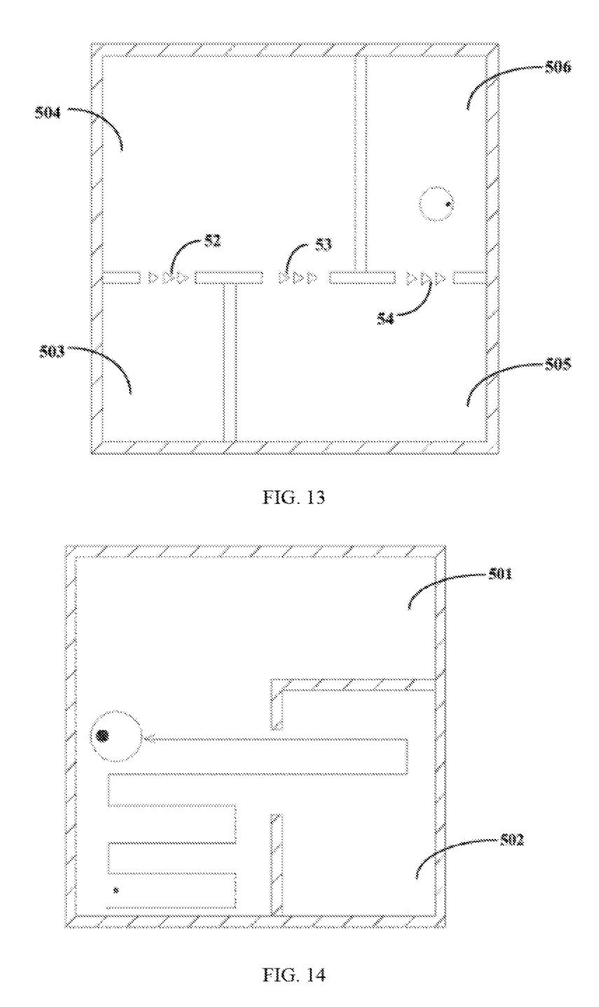

To be specific, referring to FIG. 12, a virtual obstacle boundary 51 may divide a to-be-operated region into two sub-regions 501 and 502. Referring to FIG. 13, virtual obstacle boundaries 52, 53, and 54 may divide a to-be-operated region into 4 sub-regions 503, 504, 505, and 506.

S1412: After the robot is controlled to traverse to-be-operated grids and unknown grids of a sub-region, the virtual obstacle boundaries may be deleted, the robot may then start traversing to-be-operated grids and unknown grids of another sub-region.

To be specific, referring to FIG. 12, the robot may move row by row, during the process of moving from a sub-region 501 to a sub-region 502, a virtual obstacle boundary 51 may be defined between the sub-region 501 and the sub-region 502, wherein the method for defining the boundary may refer to the block S11 to the block S13, which will not be repeatedly described. After the virtual obstacle boundary 51 becomes effective, the robot may treat the position of which the virtual obstacle boundary 51 is located as containing obstacles. During the subsequent moving process, the robot may not be able to move from the sub-region 502 to the sub-region 501 by crossing the virtual obstacle boundary 51, until the virtual obstacle boundary 51 is deleted. Therefore, the robot may firstly traverse to-be-operated grids and unknown grids within the sub-region 502, then the virtual obstacle boundary 51 may be deleted, and at the same time, the position of which the virtual obstacle boundary 51 is located may not contain obstacles, the robot may then move from the sub-region 502 to the sub-region 501 and continue traversing to-be-operated grids and unknown grids within the sub-region 501.

Referring to FIG. 13, the robot may define virtual obstacle boundaries 52, 53, and 54, successively, to divide a to-be-operated region into four sub-regions 503, 504, 505, and 506. During the subsequent moving process, the robot may firstly traverse to-be-operated grids and unknown grids within the sub-region 506, and then delete the virtual obstacle boundary 54, which is defined latest, at the same time, the position at which the virtual obstacle boundary 54 is located may not contain obstacles, the robot may then move from the sub-region 506 to the sub-region 505, and continue traversing to-be-operated grids and unknown grids within the sub-region 505. After traversing, the robot may successively delete the virtual obstacle boundaries 53 and 52, and successively traverse to-be-operated grids and unknown grids within the sub-region 504 and the sub-region 503.

Referring to FIG. 14, with available technologies in the art, during the moving process from the sub-region 501 to the sub-region 502, a virtual obstacle boundary may not be defined, when the robot moves subsequently, the robot may return from the sub-region 502 to the sub-region 501 without traversing to-be-operated grids and unknown grids within the sub-region 502, so that, after to-be-operated grids and unknown grids in the sub-region 501 are traversed, the robot may need to return to the sub-region 502 to work repeatedly, which has low work efficiency and consumes more time.

In contrast with the available technologies in the art as shown in FIG. 14, the method for controlling robot moving as described in the present disclosure may define virtual obstacle boundaries to divide to-be-operated regions into at least two sub-regions, control the robot to firstly finish traversing to-be-operated grids and unknown grids within one of the sub-regions, and then traverse to-be-operated grids and unknown grids of another sub-regions, which may improve the robot working efficiency and save working time.

S1413: during the process of moving, when the robot discovers a grid, which communicates with an operated grid and/or a to-be-operated grid, which are located in at least two sub-regions, the virtual obstacle boundary may be deleted.

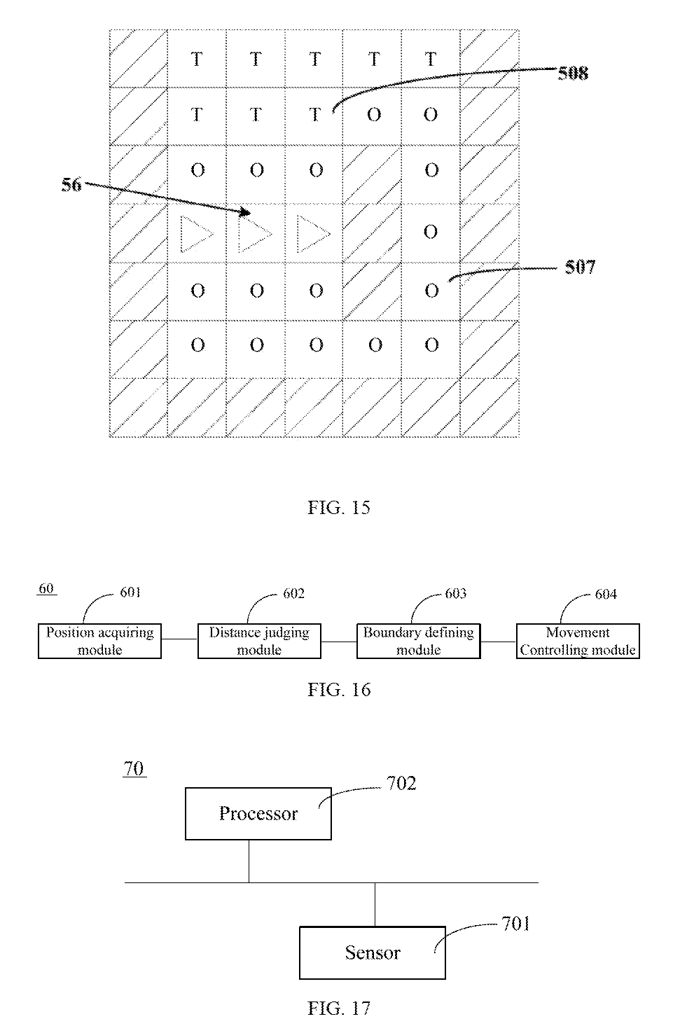

To be specific, it may be seen from blocks S11 to S13, a virtual obstacle boundary may be defined while the robot is moving from an operated region to an non-operated region, which means when a virtual obstacle boundary is defined initially, sub-regions located on two sides of the virtual obstacle boundary cannot communicate through operated and/or to-be-operated grids. However, during the robot moving process, status of grids may change, and, referring to FIG. 15, two sub-regions 507 and 508 may communicate through operated and/or to-be-operated grids. At the same time, the virtual obstacle boundary 56 may become ineffective and be deleted by the robot, saving storage space for the robot.

In the above embodiments, by acquiring position information of two adjacent obstacles located on two sides of the robot along the robot moving direction or the direction perpendicular to the moving direction, and calculating distance between the two adjacent obstacles, when the distance between the two adjacent obstacles is less than or equal to a first preset distance, a virtual obstacle boundary may be defined, and moving paths of the robot may be controlled dependent on the virtual obstacle boundary, which may not require an external virtual wall generator, virtual obstacle boundaries may be defined by the robot itself, saving cost efficiently. Also, the defined virtual obstacle boundaries may divide a to-be-operated region into at least two sub-regions, so that after completion of traversing to-be-operated grids and unknown grids within one of the sub-regions, the robot may start traversing to-be-operated grids and unknown grids within another sub-region, which effectively improves the robot working efficiency and saves working time.

Referring to FIG. 16, a structural view of a first implementation of the robot is shown. As shown in FIG. 16, a robot 60 of the present disclosure may include: a position acquiring module 601, a distance determination module 602, a boundary defining module 603, and a moving control module 604, connected in such order.

The robot 60 may be a floor sweeping robot and other types of robots, which should not be limited herein.

The position acquiring module 601 may acquire position information of two adjacent obstacles located on two sides of the robot 60 along the robot 60 moving direction or a direction perpendicular the moving direction, and calculate distance between the two adjacent obstacles.

To be specific, in one embodiment, the robot 60 may acquire position information of two adjacent obstacles located on two sides of the robot 60 along the robot 60 moving direction or the direction perpendicular the moving direction via a sensor, and calculate distance between the two adjacent obstacles, wherein the distance is transferred to the distance determination module 602.

The distance determination module 602 may be used to determine whether the distance between the two adjacent obstacles is less than or equal to a first preset distance.

To be specific, the first preset distance may be a first threshold distance preset by the robot, values may be determined dependent on actual demand, which will be not be limited herein. The distance determination module 602 may receive the distance between the two adjacent obstacles transferred from the position acquiring module 601, determine whether the distance is less than or equal to the first preset distance, and transfer the determined results to the boundary defining module 603.

The boundary defining module 603 may be used to define a virtual obstacle boundary between the two adjacent obstacles, when the distance between the two adjacent obstacles is less than or equal to the first preset distance.

To be specific, the boundary defining module 603 may receive the determined results from the distance determination module 602, when the result shows the distance is less than or equal to the first preset distance, the robot 60 may define a virtual obstacle boundary between the two adjacent obstacles by using the boundary defining module 603.

The moving control module 604 may be used to control moving paths of the robot depending on the virtual obstacle boundaries.

To be specific, in one embodiment, after a virtual obstacle boundary is defined, during the subsequent moving process, the robot 60 may determine that an obstacle is located at the position of which the virtual obstacle boundary is defined, and the robot cannot cross the virtual obstacle boundary, so that the moving paths of the robot may be controlled.

In the above embodiment, the robot may acquire position information of the two adjacent obstacles located on the two sides of the robot along the robot moving direction or the direction perpendicular to the moving direction, and calculate distance between the two adjacent obstacles, when the distance between the two adjacent obstacles is less than or equal to a first preset distance, a virtual obstacle boundary may be defined, and moving paths of the robot may be controlled dependent on the virtual obstacle boundary, which may not require an external virtual wall generator, virtual obstacle boundaries may be defined by the robot itself, saving cost efficiently.

Referring to FIG. 17, a structural view of a second implementation of the robot is shown. As shown in FIG. 17, a robot 70 of the present disclosure may include: a sensor 701 and a processor 702, which connect with each other through a bus.

The robot 60 may be a floor sweeping robot and other types of robots, which will not be limited herein.

The sensor 701 may be used acquire position information of two adjacent obstacles located on two sides of the robot along the robot moving direction or a direction perpendicular to the moving direction.

To be specific, the sensor 701 may be a distance sensor module. The robot 70 may acquire position information of the two adjacent obstacles located on the two sides of the robot 70 along the robot moving direction or the direction perpendicular to the moving direction via the sensor 701. The sensor 701 may also be a sensor of other types, as long as the position information of the two adjacent obstacles located on two sides of the robot can be acquired, the type of the sensor will not be limited herein.

The processor 702 may control the robot to move, wherein the processor 702 may also be called as a central processing unit (CPU). The processor 702 may be an integrated circuit chip, being capable of processing data. The processor 702 may also be a general processor, a digital signal processor (DSP), an application-specific integrated circuit (ASIC), a field programmable gate array (FPGA) or other programmable logic devices, discrete component gate or transistor logic devices, discrete hardware assembly. The general processor may be a microprocessor or any regular processor and the like.

The robot 70 may further include a non-transitory memory (not shown in the figure), which may store necessary instructions and data for the processor 702 to operate, for example, the position information of the two adjacent obstacles located on two sides of the robot 70 and position information of where virtual obstacle boundaries are defined, and the like.

The processor 702 may be used to calculate distance between two adjacent obstacles and determine whether the distance is less than or equal to a first preset distance. When the distance between the two adjacent obstacles is less than or equal to the first preset distance, a virtual obstacle boundary may be defined between the two adjacent obstacles, and moving paths of the robot may be controlled depending on the virtual obstacle boundaries.

The first preset distance is a first distance threshold defined by the robot 70, the value of the first distance threshold may be defined depending on specific demand, which will not be limited herein.

To be specific, in one embodiment, the processor 702 may receive the position information of the two adjacent obstacles located on two sides of the robot 70 acquired by the sensor 701, calculate distance between the two adjacent obstacles, and determine whether the distance is less than or equal to the first preset distance. When the distance is less than or equal to the first preset distance, a virtual obstacle boundary may be defined between the two adjacent obstacles. Then, the processor 702 may control the robot 70 to not cross the virtual obstacle boundary by defining obstacles at the virtual obstacle boundary, so that moving paths of the robot 70 is controlled. Of course, in other embodiments, the processor 702 may execute other blocks of an implementation of the robot moving control method as described in the present disclosure, which will not be limited herein.

The above descriptions are implementations of the present disclosure only, and should not limit the scope of the present disclosure. Any equivalent structures or transformation of the process based on the present specification and appended figures of the present disclosure used directly or indirectly in the related art should be within the scope of the present invention.

What is claimed is:

1. A method for controlling robot movement, comprising:
acquiring position information of two adjacent obstacles located on two sides of a robot along a moving direction of the robot or a direction perpendicular to the moving direction, and calculating distance between the two adjacent obstacles;
determining whether the distance between the two adjacent obstacles is less than or equal to a first preset distance;
defining a virtual obstacle boundary between the two adjacent obstacles when the distance between the two adjacent obstacles is less than or equal to the first preset distance; and
controlling moving paths of the robot based on the virtual obstacle boundary.

2. The method according to claim 1, wherein the acquiring position information of the two adjacent obstacles located on the two sides of the robot along the robot moving direction and the direction perpendicular to the moving direction comprises:
along the robot moving direction or the direction perpendicular to the moving direction, acquiring position information of a first obstacle located on one side of the robot and position information of a second obstacle located on another side of the robot, wherein regions between the first and the second obstacle is obstacle free.

3. The method according to claim 1, wherein the controlling moving paths of the robot based on the virtual obstacle boundary comprises:
when the robot subsequently moves to reach the virtual obstacle boundary, controlling the robot to move by defining obstacles located at the virtual obstacle boundary.

4. The method according to claim 3, wherein the defining the virtual obstacle boundary between the two adjacent obstacles when the distance between the two adjacent obstacle grids is less than or equal to the first preset distance comprises:
controlling the robot to continue moving so that the robot moves out of grids between the two adjacent obstacle grids, and then the virtual obstacle boundary is defined between the two adjacent obstacles.

5. The method according claim 3, wherein the defining the virtual obstacle boundary between the two adjacent obstacles when the distance between the two adjacent obstacle grids is less than or equal to the first preset distance further comprises:
when more than two virtual obstacle boundaries are defined, determining whether distance between the two virtual obstacle boundaries along any one of a first direction and a second direction perpendicular to the first direction is less than a second preset distance, and whether projections of the boundaries along a direction other than the direction used for calculating the distance have an overlapping area;
when the distance is less than the second preset distance, and the overlapping area is shown, the virtual obstacle boundary, which is defined at a later time, is selected to be deleted.

6. The method according claim 5, wherein controlling moving paths of the robot based on the virtual obstacle boundary further comprises:
during the process of moving, when the operated grids and/or the to-be-operated grids are detected to communicate with at least the two sub-regions, deleting the virtual obstacle boundary.

7. The method according to claim 3, wherein the controlling moving paths of the robot based on the virtual obstacle boundary comprises:
dividing the to-be-operated region into at least two sub-regions using the virtual obstacle boundaries; and
controlling the robot to traverse the to-be-operated grids and the unknown grids within one of the sub-regions, then deleting the virtual obstacle boundary, and controlling the robot to traverse the to-be-operated grids and the unknown grids of another sub-region.

8. The method according to claim 1, wherein, before the acquiring position information of the two adjacent obstacles located on the two sides of the robot along the robot moving direction and the direction perpendicular to the moving direction and calculating the distance between the two adjacent obstacles, the method further comprises:
acquiring a virtual map of a to-be-operated region for the robot, wherein the virtual map is divided into a plurality of grids in an array; and
during a process of the robot moving, along the moving direction and the direction perpendicular to the moving direction, detecting status of grids, which are adjacent to the robot located grid, and marking the status of the grids on the virtual map, wherein a grid, which is passed by the robot, is marked as an operated grid, a grid which is detected to have an obstacle, is marked as an obstacle grid, a grid, which is detected to be obstacle free and is not passed by the robot, is marked as a to-be-operated grid, and a grid, which is not passed by the robot and status of which is not detected, is marked as an unknown grid.

9. The method according to claim 8, wherein the acquiring position information of the two adjacent obstacles located on the two sides of the robot along the robot moving direction and the direction perpendicular to the moving direction and calculating the distance between the two adjacent obstacles comprises:
along the moving direction or the direction perpendicular to the moving direction, acquiring the two adjacent obstacle grids located on two sides of the robot, and calculating the distance between the two adjacent obstacle grids based on position information of the two adjacent obstacle grids on the virtual map.

10. The method according to claim 9, wherein
the determining whether the distance between the two adjacent obstacles is less than or equal to the first preset distance further comprises determining whether the to-be-operated grid is located adjacent to at least one side of a grid between the two adjacent grids and communicates with the unknown grid;
the defining the virtual obstacle boundary between the two adjacent obstacles, when the distance between the two adjacent obstacles is less than or equal to the first preset distance, comprises:
when the distance between the two adjacent obstacle grid is less than or equal to the first preset distance, and the to-be-operated grid is located adjacent to at least one side of a grid between the two adjacent grids and communicates with the unknown grid, the virtual obstacle boundary is defined between the two adjacent obstacle boundary.

11. A robot, comprising:
a sensor configured to acquire position information of two adjacent obstacles located on two sides of the robot along a moving direction of the robot or a direction perpendicular to the robot moving direction; and
a processor connected with the sensor and configured to calculate distance between the two adjacent obstacles, determine whether the distance is less than or equal to a first preset distance, define a virtual obstacle boundary when the distance between the two adjacent obstacles is less than or equal to the first preset distance, and control moving paths of the robot based on the virtual obstacle boundaries.

12. The robot according to claim 11, wherein the sensor acquiring the position information of the two adjacent obstacles located on the two sides of the robot along the robot moving direction or the direction perpendicular to the moving direction comprises:
along the robot moving direction or the direction perpendicular to the moving direction, the sensor acquiring position information of a first obstacle located on one side of the robot and position information of a second obstacle located on another side of the robot, wherein a region between the first and the second obstacle is obstacle free.

13. The robot according to claim 11, wherein the processor is further configured to control the robot to move by defining obstacles at the virtual obstacle boundary, when the robot subsequently moves to reach the virtual obstacle boundary.

14. The robot according to claim 13, wherein defining the virtual obstacle boundary when the distance between the two adjacent obstacles is less than or equal to the first preset distance comprises:
the processor controlling the robot to continue moving out of grids between the two adjacent obstacle grids, and then defining the virtual obstacle boundary between the two adjacent obstacles.

15. The robot according to claim 13, wherein defining the virtual obstacle boundary when the distance between the two adjacent obstacles is less than or equal to the first preset distance further comprises:
when more than two virtual obstacle boundaries are defined, the processor determining whether distance between the two virtual obstacle boundaries along any one of a first direction and a second direction perpendicular to the first direction is less than a second preset distance, and whether projections of the boundaries along a direction other than the direction used for calculating the distance have an overlapping area;
when the distance between the two virtual obstacle boundaries along any one of the first direction and the second direction is less than the second preset distance, and the overlapping area is shown, the virtual obstacle boundary, which is defined at a later time, is selected to be deleted.

16. The robot according to claim 15, wherein the processor controlling moving paths of the robot based on the virtual obstacle boundaries further comprises:
during the process of moving, when the operated grids and/or to-be-operated grids are detected to communicate with at least two of the sub-regions, the processor deleting the virtual obstacle boundary.

17. The robot according to claim 13, wherein the processor controlling moving paths of the robot based on the virtual obstacle boundaries comprises:
dividing the to-be-operated region into at least two sub-regions using the virtual obstacle boundaries;
controlling the robot to traverse the to-be-operated grids and the unknown grids within one of the sub-regions, then deleting the virtual obstacle boundary, and then controlling the robot to traverse the to-be-operated grids and the unknown grids within another sub-region.

18. The robot according to claim 11, wherein, before the sensor acquiring the position information of the two adjacent obstacles located on the two sides of the robot along the robot moving direction or the direction perpendicular to the moving direction and calculating the distance between the two adjacent obstacles,
the processor is further configured to acquire a virtual map of a to-be-operated region for the robot via the sensor, wherein the virtual map is divided into a plurality of grids in an array;
during a process of moving, the sensor is configured to detect status of grids adjacent to the robot located grid along the robot moving direction and the direction perpendicular to the moving direction, further, the processor is configured to mark the status of the grids on the virtual map, wherein a grid, which is passed by the robot is marked as a operated grid, a grid, which is detected to have an obstacle, is marked as an obstacle grid, a grid, which is detected to be obstacle free and is not passed by the robot, is marked as a to-be-operated grid, and a grid, which is not passed by the robot and the status of which is not detected, is marked as an unknown grid.

19. The robot according to claim 18, wherein
the sensor is further configured to acquire two adjacent obstacle grids, which are located on two sides of the robot along the robot moving direction or the direction perpendicular to the moving direction;
the processor is further configured to calculate distance between the two adjacent obstacle grids based on position information of the two adjacent obstacle grids on the virtual map.

20. The robot according claim 19, wherein
the processor determining whether the distance between the two adjacent obstacle grids is less than or equal to the first preset distance comprises determining whether the to-be-operated grid is located adjacent to at least one side of a grid between the two adjacent obstacle grids and communicates with the unknown grid;
defining the virtual obstacle boundary when the distance between the two adjacent obstacles is less than or equal to the first preset distance comprises:
when the distance between the two adjacent obstacles is less than or equal to the first preset distance and the to-be-operated grid is located adjacent to at least one side of a grid between the two adjacent obstacle grids and communicates with the unknown grid, defining the virtual obstacle boundary between the two adjacent obstacle grids.
